(19) United States
(12) Patent Application Publication
(10) Pub. No.: US 2014/0000114 A1
(43) Pub. Date: Jan. 2, 2014

(54) SHAVING RAZOR CARTRIDGE

(71) Applicant: THE GILLETTE COMPANY, Boston, MA (US)

(72) Inventors: Christian Reber Wester, San Diego, CA (US); Stephen Charles Witkus, Northbridge, MA (US)

(73) Assignee: The Gillette Company, Boston, MA (US)

(21) Appl. No.: 13/867,281

(22) Filed: Apr. 22, 2013

Related U.S. Application Data
(60) Provisional application No. 61/665,347, filed on Jun. 28, 2012.

(51) Int. Cl. B26B 21/40

(52) U.S. Cl. CPC B26B 21/4012; B26B 21/4068
USPC 30/32; 29/428

(57) ABSTRACT

A wet shaving razor cartridge having a cap, a guard in front of the cap, with the guard having a top surface bowed in an upward direction from a pair of lateral ends of the guard toward a mid-line of the guard. A blade is between the guard and the cap. The blade has an elongated edge bowed in an upward direction from a pair of lateral ends of the blade toward a mid-line of the blade. A bowed platform is between the guard and the cap. The platform is bowed in an upward direction from a pair of lateral platforms toward a center platform. A top surface of the center platform is positioned above a plane tangent to the pair of lateral end platforms.

### FIELD OF THE INVENTION

The present invention relates to shaving razor cartridges and more particularly to wet shaving cartridges having one or more blades secured to a cartridge housing and methods of manufacture thereof.

### BACKGROUND OF THE INVENTION

In general, shaving razors of the wet shave type include a cartridge or blade unit with at least one blade with an elongated cutting edge which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor). The connection of the cartridge to the handle provides a pivotal mounting of the cartridge with respect to the handle so that the cartridge angle adjusts to follow the contours of the surface being shaved.

Razor cartridges usually include a guard which contacts the skin in front of the blade(s) and a cap for contacting the skin behind the blade(s) during shaving. The cap and guard aid in establishing the so-called “shaving geometry”, i.e., the parameters which determine the blade orientation and position relative to the skin during shaving, which in turn have a strong influence on the shaving performance and efficacy of the razor. The cap and the guard may aid in establishing the exposure of the blades. Exposure may be defined as the position of the cutting edge of a blade relative to a tangent line drawn from the skin contacting element (e.g., a blade) in front of the cutting edge to the skin contacting element behind the cutting edge (e.g., the cap). A cutting edge positioned above the tangent line would have a positive exposure and a cutting edge positioned below this line would have a negative exposure. A cutting edge that lies on the tangent line has a neutral exposure. Another shaving parameter that significantly effects shave performance is known as span. Span may be defined as the distance from the cutting edge to a skin contacting element immediately in front of the cutting edge (e.g., another blade or the guard). Another parameter that may influence shaving performance is the blade angle. The blade angle is the angle of the cutting edge relative to the tangent line (described above).

Over the years shaving razors with various numbers of blades have been proposed in the patent literature and commercialized, such as the Mach 3 razor by The Gillette Company. The blades of the Mach 3 razor are secured to a cartridge housing using clips. The clips extend over the blades and about the periphery of the housing. Clips, such as those use for the Mach 3 razor, are typically used to retain spring loaded blades. As shown, for example, in U.S. Pat. No. 4,378,634, blades can move up and down in slots in a cartridge housing against resilient arms during shaving. The metal clips on the housing retain the blades in the slots and determine the positions of the cutting edges of the blades in the at-rest position. In manufacture, the blades are first loaded into the housing; then a U-shaped clip is positioned over the housing and blades, and the legs of the clip are bent around the bottom of the housing. After the clips are secured to the housing the resilient arms bias the blades against the clips. The resilient arms must be molded from a plastic that is strong enough to flex and support the blades and has sufficient stress relaxation resistance. Accordingly, less expensive, lower performing plastics such as high impact polystyrene (HIPS) are not typically used.

Although clips have proven very successful for spring mounted blades, securing fixed blades have proven more difficult to retain using clips because of manufacturing tolerances. The resilient arms for spring mounted blades account for tolerance variations. However, if there is too much clearance between the blade and the clip in a cartridge without resilient arms, the blade may not be secured properly to the housing. For example, the blades may move or vibrate during a shaving stroke, thus causing nicks and cuts. If there is not sufficient clearance in a fixed blade cartridge between the blade and the clip, the blade and/or the housing may be damaged (e.g., crushed) during the assembly process, which may also adversely impact shaving performance.

What is needed, then, is a wet shaving razor cartridge having one or more fixed mounted blades, for example that account for tolerance variations without negatively impacting shaving performance. It may also be desirable to provide a manufacturing method for assembling fixed mounted blades that accounts for tolerance variations without negatively impacting shaving performance. The wet shaving razor cartridge assembly, is preferably simpler, cost-effective, reliable, durable, easier and/or faster to manufacture, and easier and/or faster to assemble with more precision.

### SUMMARY OF THE INVENTION

In one aspect, the invention features, in general, a wet shaving razor cartridge having a cap, a guard in front of the cap, with the guard having a top surface bowed in an upward direction from a pair of lateral ends of the guard toward a mid-line of the guard. A blade is positioned between the guard and the cap. The blade has an elongated edge bowed in an upward direction from a pair of lateral ends of the blade toward a mid-line of the blade. A bowed platform is between the guard and the cap. The platform is bowed in an upward direction from a pair of lateral platforms toward a center platform. A top surface of the center platform is positioned above a plane tangent to the pair of lateral end platforms.

Certain aspects of the invention may optionally include the center platform and the lateral platforms forming a continuous platform. Alternatively, the center and lateral end platforms may be spaced apart. Certain aspects may also optionally include the cap with a top surface bowed in an upward direction from a pair of lateral end portions of the cap toward a mid point of the cap. Certain aspects of the invention may include the elongated edge of the blade being spaced apart from at least one of the lateral end platforms by a vertical distance of about 0.025 mm to about 0.25 mm. The guard in certain aspects of the invention may be segmented or non-segmented.

In another aspect, the invention features, in general, a method of manufacturing a wet shaving cartridge by providing a housing having a guard with a top surface bowed in an upward direction from a pair of lateral end portions toward a mid point of the guard. At least one blade is mounted to the housing. The blade is bent around a portion of the housing and the blade is then secured to the housing. Certain aspects of the invention may optionally include the bending of the blade around the portion that is a center platform. The method may also optionally include biasing the blade away from a pair of lateral end platforms of the housing and against the center platform.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a perspective view of a shaving razor cartridge.

FIG. 2 is a perspective view of a blade of the shaving razor cartridge of FIG. 1.

FIG. 3 is an exploded perspective view of the shaving razor cartridge of FIG. 1.

FIG. 4 is a schematic view of the shaving razor cartridge of FIG. 1.

FIG. 5 is a perspective view of a cap of the shaving razor cartridge of FIG. 1.

FIG. 6 is a section view of the shaving razor cartridge of FIG. 1, taken generally along the line 6-6, of FIG. 1.

### DETAILED DESCRIPTION OF THE INVENTION

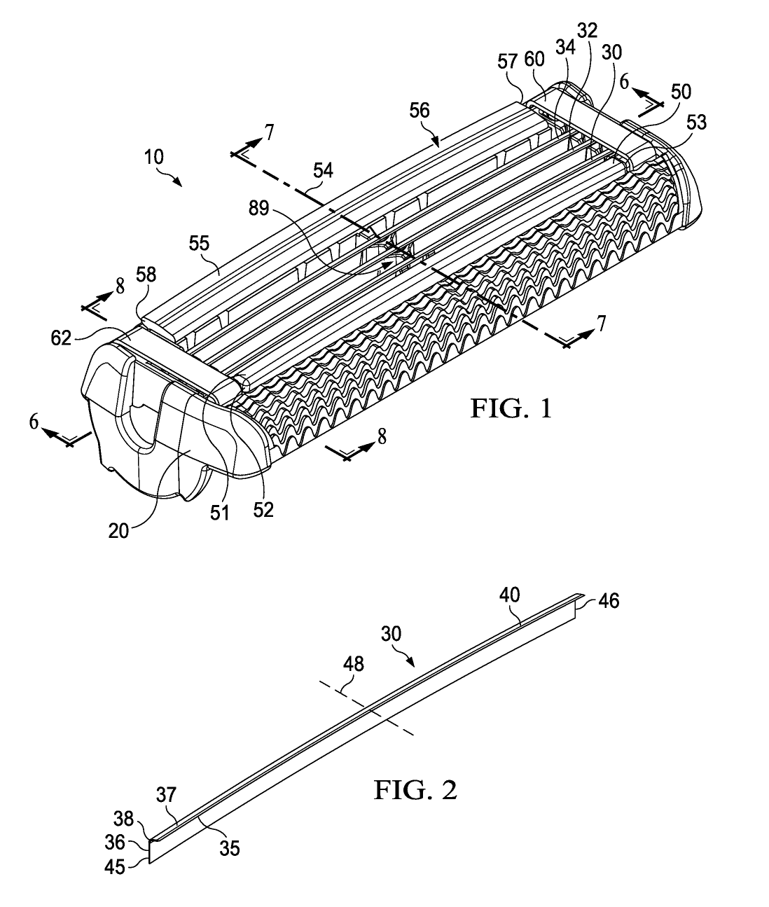

Referring to FIG. 1, one embodiment of the present disclosure is shown illustrating a shaving cartridge 10 (e.g., a wet shaving razor cartridge). The wet shaving razor cartridge 10 may be mounted to a shaving razor handle (not shown). The shaving cartridge 10 may be pivotably (i.e., rotation of the cartridge 10 about an axis relative to the shaving razor handle) and/or detachably engaged to the shaving razor handle. The shaving cartridge 10 may include a housing 20 dimensioned to receive at least one blade (e.g., a first blade 30, a second blade 32 and a third blade 34). Although three blades 30, 32 and 34 are shown, the housing 20 may have more or fewer blades depending on the desired performance and cost of the shaving razor cartridge 10. The blades 30, 32 and 34 may be mounted on one or more rigid supports of the housing 20 (e.g., not mounted on spring biased supports) such that the blades 30 do not float up and down relative to the housing 20 during a shaving stroke. The housing 20 may have a guard 50 in front of the blades 30, 32 and 34 and a cap 55 behind the blades 30, 32 and 34. The guard 50 and the cap 55 may aid in establishing a proper shaving geometry (e.g., blade exposure) for the shaving cartridge 10. The housing 20 may be rigid so it does not flex under normal shaving conditions. Accordingly, a consistent shaving geometry may be provided. In certain embodiments, the guard 50 may be continuous (as shown in FIG. 1) or segmented (e.g., comb guard) to aid in the alignment of hair during a shaving stroke.

The blades 30, 32 and 34 may be mounted to the housing 20 and secured in at least one direction by at least one clip 60 and 62. For example, the clips 60 and 62 may be bent over the blades 30, 32 and 34 and around at least a portion of the housing 20 to secure the blades 30, 32 and 34 within the housing 20. Although the clips 60 and 62 are shown as two separate components fixing the blades 30 within the housing 20, the clips 60 and 62 may also be a single piece design. In addition, the clips 60 and 62 may not necessarily be bent or formed around a portion of the housing 20 to fix the blades 30, 32 and 34 relative to the housing 20. For example, the clips 60 and 62 may be positioned over the blades 30, 32 and 34 and snapped fit, press fit, glued, or ultrasonically welded to the housing 20 to fix the clips 60 and 62 to the housing 20. The clips 60 and 62 may comprise a metal (e.g., aluminum or stainless steel) or a polymeric material (e.g., Noryl™ (a blend of polyphenylene oxide (PPO) and polystyrene developed by General Electric Plastics, now SABIC Innovative Plastics), acrylonitrile butadiene styrene (ABS), acetal, polypropylene, high impact polystyrene, or any combinations thereof).

In certain embodiments, the housing 20 may be sufficiently rigid so the housing 20 does not flex under normal shaving conditions. For example, the housing 20 may be molded from Noryl™ (a blend of polyphenylene oxide (PPO) and polystyrene developed by General Electric Plastics, now SABIC Innovative Plastics). As will be explained in greater detail below, the housing 20 may be molded from less expensive and lower performance polymeric materials if the blades 30, 32 and 34 are supported by one or more rigid blade supports instead of resilient arms. Accordingly, other rigid polymers having a Shore A hardness of about 60 to 140 may be used, including, but not limited to acrylonitrile butadiene styrene (ABS), acetal, polypropylene, high impact polystyrene, or any combinations thereof. The guard 50 may be molded from the same material as the housing 20 or a softer material. For example, the guard 20 may be molded from materials having a Shore A hardness of about 20 to about 70, such as thermoplastic elastomers (TPEs) or rubbers. In certain embodiments, an elastomeric member 70 may be molded to the housing 20 immediately in front of the guard 50. The elastomeric member 70 may aid in stretching the skin during a shaving stroke. The elastomeric member 70 may be molded from materials having a shore A hardness of about 20 to about 70, such as thermoplastic elastomers (TPEs) or rubbers. The cap 55 may be molded from the same material as the housing 20. In certain embodiments, the cap 55 may comprise an elongated strip containing a shaving aid to provide lubrication to the surface of the skin during shaving.

Referring to FIG. 2, a perspective view of the blade 30 is shown. It is understood that the blade 30 is representative of the structure and features for the blades 32 and 34. In certain embodiments, the blades 30, 32 and 34 may integrally be formed from a single piece of material that is sharpened either prior to bending or after bending. In most instances, the material is selected from the group of materials consisting of stainless steel, aluminum, ceramic, glass, plastic, and combinations thereof. The material may be bent using any suitable means known for the particular material being bent. The blade 30 may have an elongated base portion 36 along one lengthwise side, a tapered portion 37, along an opposing lengthwise side, narrowing to a sharpened elongated edge 35, and a bent portion 38 that interconnects the elongated support portion 36 and the tapered portion 37. The tapered portion 37 may have a top surface 40. The elongated edge 35 may terminate in a relatively sharp point (e.g., for cutting hairs), while the base portion 36 may terminate in a relatively blunt end region that is received within a respective blade slot 100a 100b, 102a, 102b, and 104a, 104b.

The assembly of the blades 30 within the housing 20 may impart a bow to the blades 30 (e.g., a top surface 40 of the blades 30). For example, the elongated edge 35 may be bowed in an upward direction from a pair of lateral ends 45 and 46 of the blade toward a mid-line 48 of the blade. Bow is a term used to describe an arching normal to the plane in which the portion of the elongated edge lies. Blades for shaving razors typically try to minimize blade bow (e.g., about +0.0004 to about −0.002 inch (+0.01 to −0.05 millimeter) or less across the length of the tapered portion). By reducing the levels of bow in blade portion and/or base portion, the comfort of the user and/or the cutting performance of the blades can be improved. However, imparting a bow to the blade may improve retention of the blades 30, 32, and 34 within the housing 20. The elongated edge 35 may slope in an upward direction from the pair of lateral ends 45 and 46 of the blade 30 toward the mid-line 48 of the blade 30. Accordingly, the elongated edge 35 at the mid-line 48 may be positioned above a straight line L1 connecting the lateral ends 45, 46 of the blade 30. In certain embodiments, a vertical distance (e.g., generally transverse to the blade edge) along the mid-line 48 of the elongated edge 35 to the straight line L1 connecting opposite lateral ends 45 and 46 of the elongated edge 35 may be about 0.05 mm, 0.07 mm, or 0.10 mm to about 0.15 mm, 0.20 mm or 0.25 mm.

The elongated base portion 36 may have a thickness of about 0.075 mm, 0.085 mm, or 0.095 mm to about 0.105 mm, 0.115 mm, or 0.127 mm. The thickness of the elongated base portion 36 may provide for a sufficient inner bend radius R1 of the bent portion 38. The thickness of the blades 30, 32 and 34 may facilitate the bending (i.e., bow) of the blade during securement within the housing 20. Relative to the elongated base portion 36, the tapered portion 37 may extend at an angle of about 90 degrees, 95 degrees, or 100 degrees to about 105 degrees, about 110 to about 115 degrees). The elongated edge 35 of the tapered portion 37 may have a wedge-shaped configuration with an ultimate tip having a radius less than about 1000 angstroms (e.g., about 100 angstroms, 150 angstroms, or 200 angstroms to about 500 angstroms, 700 angstroms, or 950 angstroms). An advantage of the disclosed bent blades 30, 32 and 34 having a bent portion 38 is that they can be used in a razor cartridge as an alternative to a planar razor blade mounted on a thicker bent blade support. The bent blades 30, 32 and 34 may facilitate improved rinsing of the cartridge 10.

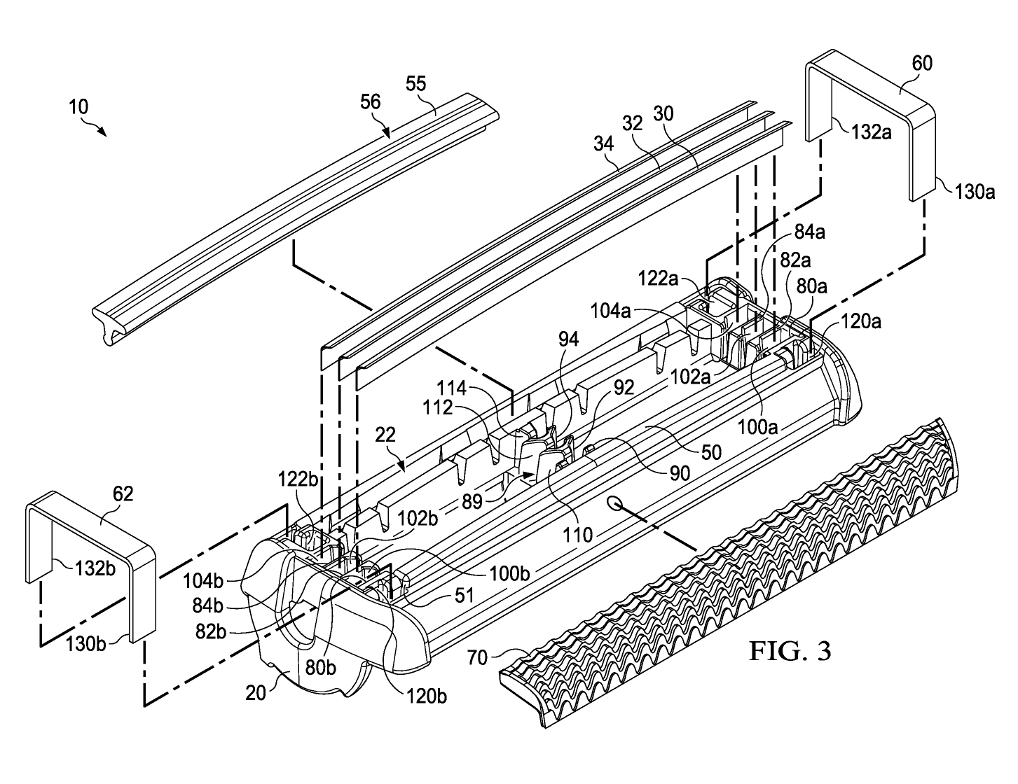

Referring to FIG. 3, an exploded view of wet shaving razor cartridge 10 is shown. The cap 55 may be at least partially secured within a recess 22 defined by the housing 20. The elastomeric member 70 may be co-injection molded to the housing 20 in front of the guard 50. The housing 20 may comprise one or more platforms located between the guard 50 and the cap 55 for supporting the blades 30, 32 and 34. For example, the housing 20 may comprise a first lateral end platform 80a spaced apart from a second lateral end platform 80b for supporting the blade 30. A center platform 90 may be positioned between the respective lateral end platforms 80a and 80b. As will be explained in greater detail below, the center platform 90 may facilitate securing the blades 30 to the housing 20. The housing 20 may have more lateral end platforms to support additional blades depending on the desired number of blades. For example, two additional pairs of lateral platforms (82a and 82b and 84a and 84b) and two additional corresponding center platforms (92 and 94) may be provided for supporting the blades 32 and 34. In certain embodiments, a non-segmented platform may be provided (i.e., a uniform platform that bows in an upward direction from a pair of lateral end platforms toward a center platform).

The housing 20 may define a first pair of lateral blade slots 100a and 100b for receiving at least a portion of the blade 30. An additional pair of lateral blade slots 102a and 102b may be provided for a second blade 32. Accordingly, the third blade 34 may be positioned within a pair of lateral blade slots 104a and 104b. The housing 20 may also define one or more center blade slots 110, 112 and 114 for receiving at least a portion of the respective blades 30, 32 and 34. During assembly, the blade 30 (e.g., the base portion 36) may be positioned in the corresponding lateral blade slots 100a and 100b and the corresponding center blade slot 110. The additional blades 32 and 34 may be placed within the housing 20 in a similar fashion. One or more of the clips 60 and 62 may be positioned over the blades 30, 32 and 34. During assembly, the clips 60 and 62, may exert a downward force against the lateral ends 45 and 46 of the blades 30, 32 and 34 causing the blades 30, 32, and 34 to bend. The clips 60 and 62 may then be fastened to the housing 20 to secure the blade 30 within the respective pair of lateral blade slots 100a and 100b and the center blade slot 110. In certain embodiments, the blades 30, 32 and 34 may be biased against the clips 60 and 62 after the clips 60 and 62 are secured to the housing 20. The housing 20 may define a first pair of openings 120a and 122a dimensioned to receive a pair of legs 130a and 132a of the clip 60. The pair of legs 130a and 132a may pass through the openings 120a and 122a and may be bent around the bottom of the housing 20 to secure the blades 30, 32 and 34 in place. The housing may define a second pair of openings 120b and 122b to receive a pair of legs 130b and 132b of the other clip 62. Similarly, the pair of legs 130b and 132b may pass through the openings 120b and 122b and may be bent around the bottom of the housing 20 to secure the blades 30, 32 and 34 in place. In certain embodiments, the clips 60 and 62 may be secured to the housing 20 simultaneously for proper positioning of the blades 30.

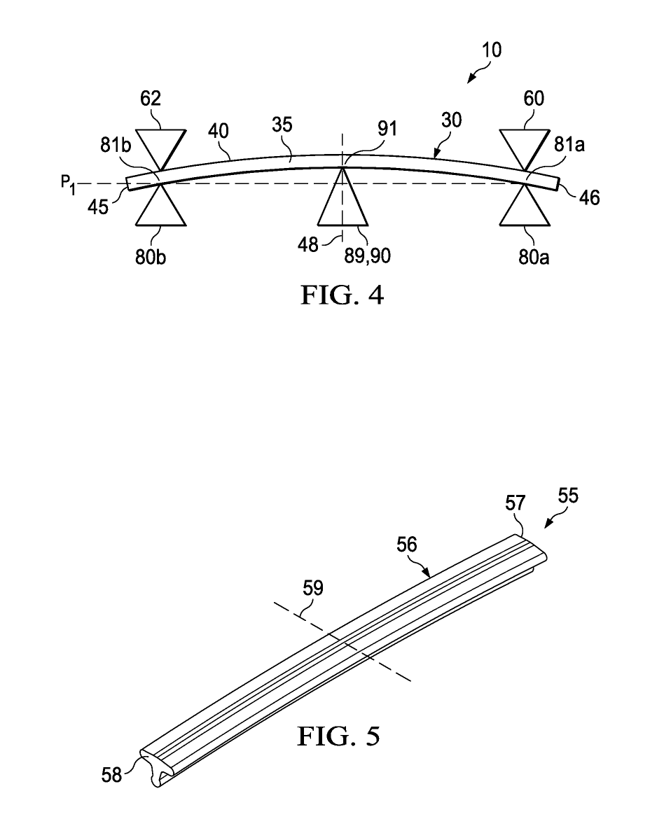

Referring to FIG. 4, schematic view of the shaving razor cartridge 10 is shown illustrating the lateral end blade platforms 80a and 80b, the center platform 90, the blade 30, and the clips 60 and 62. A top surface 81a of the first lateral end platform 80a and a top surface 81b of the second lateral end platform 80b may be positioned substantially on the same plane (P1) for supporting the blade 30 (see FIG. 3). For example, the plane P1 may be tangent to the top surfaces 81a and 81b of the first and second lateral end platforms 80a and 80b. The center platform 90 may have a top surface 91 that is positioned above the plane P1 of the first and second lateral end platforms 80a and 80b. In certain embodiments, top surface 91 may be spaced apart from plane P1 by a vertical distance of about 0.05 mm, 0.10 mm, or 0.15 mm to about 0.25 mm, 0.4 mm, or 0.5 mm. The spacing of the top surface 91 from the plane P1 (i.e., the height of the lateral end supports 80a and 80b relative to the center support 90) may facilitate fixedly the blade 30 biasing against the clips 60 and 62 to secure the blade 30 in place within the housing 20.

The process of securing the blades 30, 32 and 34 to the housing 20 with the clips 60 and 62 may impart a bend to the blades 30, 32 and 34 (e.g., a top surface 40 of the blade 30). For example, FIG. 4 illustrates the blade 30 having a bowed top surface 40. The top surface 40 may have a generally convex profile such that the top surface 40 is bowed in an upward direction from each lateral end 45 and 46 of the blade 30 toward the mid-line 48 of the blade 30. The clips 60 and 62 may exert a downward force against the blade 30 (e.g., the ends 45 and 46 of the blade 30). The blade 30 may bend and/or form about the center platform 90 as the clips 60 and 62 are secured to the housing 20 because the top surface 91 of the center platform 90 is positioned above the top surfaces 81a and 81b of the lateral end platforms 80a and 80b. Accordingly, the blade 30 may contact the top surface 91 of the center platform 90 first. The clips 60 and 62 may then force the lateral ends 45 and 46 of blade 30 into contact with the pair of lateral end platforms 80a and 80b, thus bending the blade 30 about the center platform 90. Once the clips 60 and 62 are fastened to the housing 20, the blade 30 may spring back against the clips 60 and 62 to hold the blade 30 in place. For example, in certain embodiments, there may be a gap between the blade 30 and the lateral end platforms 80a and 80b, but the blade 30 may be securely held in place by the blade 30 bending over the center platform 90 and being biased in an upward direction to contact the clips 60 and 62. In certain embodiments, the blade 30 may contact the top surface 91 of the center platform 90, but may be spaced apart from lateral platforms 80a and 80b (e.g., top surfaces 81a and 81b) by a vertical distance of about 0.025 mm, 0.05 mm, or 0.075 mm to about 0.1 mm, 0.15 mm or 0.25 mm. Accordingly, the blade 30 may function as a spring member taking up tolerances of the assembly. It is understood, that the other blades 32 and 34 may be secured to the housing 20 with the clips 60 and 62 in a similar fashion.

Imparting a bow to the blades 30, 32 and 34 may improve retention of the blades 30, 32, and 34 within the housing 20. However, the bowed elongated edge 35 may adversely impact shaving performance because the shaving geometry may not be consistent along the length of the blades 30 (e.g., the blades 30 do not have a constant exposure along their length). The bowed elongated edge 35 of the blade 30 may adversely impact shaving performance because the shaving geometry may not be consistent along the length of the blade. For example, the elongated edge 35 of the blade 30 toward the clips 60 and 62 may be further below a tangent line extending from the guard to the cap (i.e., shaving plane) compared to the blade edge 35 toward the mid line of 48 of the blade 30 (e.g., at the center blade platform 90). This shaving geometry may result in a close shave toward the center blade platforms, but a less close shave toward the lateral ends 45 and 46 of the blade 30. Furthermore, this geometry may result in a comfortable shave towards the lateral ends 45 and 46 of the blade 30 and a more aggressive and less comfortable shave toward the mid line 48 of the blade 30. Accordingly, fine-tuning the performance of the shaving razor cartridge (e.g., balancing comfort and closeness) may be very difficult. A blade with increased bow may still provide high levels of comfort and performance if the bow of the blades 30, 32 and 34 are compensated modifying the structure of the guard 50 and/or the cap 55 to provide a consistent shaving geometry along the length of the blades 30, 32 and 34.

In certain embodiments, the bow of the blades 30, 32 and 34 may be compensated by bowing the top surface of the cap and/or guard that establishes the shaving plane. Referring to FIG. 5, the cap 55 is shown having a bowed (e.g., concave) top surface extending gradually in an upward direction from a first and second lateral ends 57 and 58 toward a mid line 59 of the cap 55. The top surface 61 of the cap 55 may arch normal to the plane connecting the opposing lateral ends 57 and 58 of the cap 55. The top surface 61 of the cap 55 may also arch in a second direction (e.g., along mid-line 48) transverse to the plane connecting the opposing lateral ends 57 and 58 of the cap 55. Accordingly, the top surface of the cap along the mid-line 59 may be positioned above a straight line connecting the lateral ends of the cap. In certain embodiments, a vertical distance from the mid-line 59 of the top surface 61 of the cap 55 to a straight line connecting opposite lateral ends of the cap 55 may be about 0.05 mm, 0.075, or 0.10 mm to about 0.15 mm, 0.20 mm, or 0.25 mm. In certain embodiments, the vertical distance for the cap 55 may be substantially the same as the vertical distance for the blade 30.

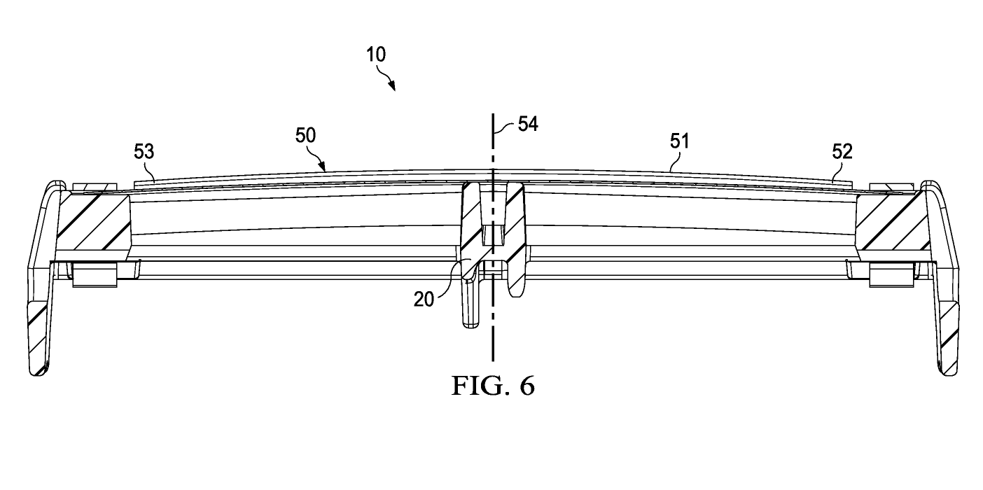

Referring to FIG. 6, the guard 50 is shown having a bowed (e.g., concave) top surface 51 extending gradually in an upward direction from a first and second lateral ends 52 and 53 toward a mid line 54 of the guard 50. The top surface 51 of the guard 50 may arch normal to the plane connecting the opposing lateral ends 52 and 53 of the guard 50. The top surface 51 of the guard 50 may also arch in a second direction (e.g., along mid-line 54) transverse to the plane connecting the opposing lateral ends 52 and 53 of the cap 55. Accordingly, the top surface 51 of the guard along the mid-line 54 may be positioned above a straight line connecting the lateral ends 52 and 53 of the guard 50. In certain embodiments, a vertical distance from the mid-line 54 of the top surface 51 of the guard 50 to a straight line connecting opposite lateral ends of the guard 50 may be about 0.05 mm to about 0.25 mm. In certain embodiments, the vertical distance for the guard 50 may be substantially the same as the vertical distance for the blade 30 and/or the cap 55. The bow of the guard 50 and the bow of the blades 30, 32 and 34 may result in a constant guard height (relative to the elongated edge 35 of the blade 30) along the entire length of the guard 50. The constant guard height may result in a more consistent shave (e.g., closeness and comfort) across the length of the cartridge.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of manufacturing a wet shaving cartridge comprising:
providing a housing having a guard with a top surface bowed in an upward direction from a pair of lateral end portions toward a mid point of the guard;
mounting at least one blade in the housing;
bending the blade about a portion of the housing; and
securing the blade to the housing.

2. The method of claim 1 wherein the portion of the housing comprises a center platform.

3. The method of claim 2 further comprising biasing the blade away from a pair of lateral end platforms of the housing and against the center platform.

4. The method of claim 3 wherein the center platform has a top surface positioned above a plane tangent to the lateral end platforms.

5. The method of claim 4 wherein the top surface of the center platform is positioned above the plane tangent to the lateral end platforms by a vertical distance of about 0.05 mm to about 0.25 mm.

6. The method of claim 4 wherein the top surface of the center platform is positioned above the plane tangent to the lateral end platforms by a vertical distance of about 0.1 mm to about 0.25 mm.

7. The method of claim 1 further comprising providing a cap behind the blade, the cap having a top surface bowed in an upward direction from a pair of lateral ends of the cap toward a mid line of the cap.

8. The method of claim 7 wherein the cap is mounted to the housing.

9. The method of claim 2 wherein said securing the blade to the housing comprises mounting a clip over the blade and securing the clip to the housing.

10. The method of claim 9 wherein the blade is biased against the clip.

11. The method of claim 1 wherein said securing the blade to the housing comprises staking.

12. The method of claim 1 wherein said bending occurs during said securing.

13. The method of claim 1 wherein the portion of the housing comprises an elongated platform bowed in an upward direction from a pair of lateral ends toward a mid line of the platform.

14. A wet shaving razor cartridge comprising:
a cap,
a guard in front of the cap, the guard having a top surface bowed in an upward direction from a pair of lateral ends of the guard toward a mid-line of the guard;
a blade between the guard and the cap, the blade having an elongated edge bowed in an upward direction from a pair of lateral ends of the blade toward a mid-line of the blade; and
a bowed platform between the guard and the cap, wherein the platform is bowed in an upward direction from a pair of lateral platforms toward a center platform and a top surface of the center platform is positioned above a plane tangent to the pair of lateral end platforms.

15. The wet shaving razor cartridge of claim 14 wherein the center platform and the lateral platforms form a continuous platform.

16. The wet shaving razor cartridge of claim 14 wherein the center and lateral end platforms are spaced apart.

17. The wet shaving razor cartridge of claim 14 wherein a top surface of the center platform is positioned above a plane tangent to the pair of lateral end platforms by a vertical distance of about 0.05 mm to about 0.25 mm.

18. The wet shaving razor cartridge of claim 14 wherein the cap has a top surface bowed in an upward direction from a pair of lateral end portions of the cap toward a mid point of the cap.

19. The wet shaving razor cartridge of claim 14 wherein the elongated edge is spaced apart from at least one of the lateral end platforms by a vertical distance of about 0.025 mm to about 0.25 mm.

20. The wet shaving razor cartridge of claim 14 wherein the guard is non-segmented.
